(19) United States
(12) Patent Application Publication
(10) Pub. No.: US 2023/0329484 A1
(43) Pub. Date: Oct. 19, 2023

(54) DUAL GRIND ADAPTER KIT

(71) Applicant: LEM Products Holdings, LLC, West Chester, OH (US)

(72) Inventor: Tyandra Zeinner, Cincinnati, OH (US)

(21) Appl. No.: 18/134,273

(22) Filed: Apr. 13, 2023

Related U.S. Application Data
(60) Provisional application No. 63/330,382, filed on Apr. 13, 2022.

(51) Int. Cl. A47J 43/07; A47J 43/08

(52) U.S. Cl. CPC A47J 43/0711; A47J 43/082; A47J 2043/04454

(57) ABSTRACT

An exemplary auger stud extends along a longitudinal rotational axis that defines a proximal direction and a distal direction opposite the proximal direction. The auger stud generally includes a body portion, a stem, a first grind plate mounting section, a second grind plate mounting section, and a grind knife mounting section. The stem extends distally from the body portion. The first grind plate mounting section is positioned proximally of the body portion, and has a first circular cross-sectional geometry. The second grind plate mounting section is positioned proximally of the first grind plate mounting section, and has a second circular cross-sectional geometry. The grind knife mounting section is positioned between the first grind plate mounting section and the second grind plate mounting section, and has a first non-circular cross-sectional geometry.

### CROSS-REFERENCE TO RELATED APPLICATIONS

The present application claims the benefit of U.S. Provisional Patent Application No. 63/330,382, filed Apr. 13, 2022, the contents of which are incorporated by reference in their entirety.

### TECHNICAL FIELD

The present disclosure generally relates to grinders, and more particularly but not exclusively relates to adapter kits and auger studs for converting a single-stage grinder into a multi-stage grinder.

### BACKGROUND

Grinders are often used to process food products (e.g., meat), and frequently come in single-stage configurations and dual-stage configurations. Although there exist certain adapter kits for converting single-stage grinders into dual-stage grinders, these kits typically suffer from one or more limitations or drawbacks, such as those related to requiring excessive new parts and/or ease of assembly and disassembly. For these reasons among others, there remains a need for further improvements in this technological field.

### SUMMARY

An exemplary auger stud extends along a longitudinal rotational axis that defines a proximal direction and a distal direction opposite the proximal direction. The auger stud generally includes a body portion, a stem, a first grind plate mounting section, a second grind plate mounting section, and a grind knife mounting section. The stem extends distally from the body portion. The first grind plate mounting section is positioned proximally of the body portion, and has a first circular cross-sectional geometry. The second grind plate mounting section is positioned proximally of the first grind plate mounting section, and has a second circular cross-sectional geometry. The grind knife mounting section is positioned between the first grind plate mounting section and the second grind plate mounting section, and has a first non-circular cross-sectional geometry. Further embodiments, forms, features, and aspects of the present application shall become apparent from the description and figures provided herewith.

### BRIEF DESCRIPTION OF THE FIGURES

FIG. 1 is a perspective view of a dual grind grinder according to certain embodiments, the grinder including a head, an auger, and a grind assembly according to certain embodiments.

FIG. 2 is a perspective view of the head and dual grind assembly of the grinder illustrated in FIG. 1.

FIG. 3 is a cross-sectional illustration of the head, the auger, and the dual grind assembly of the grinder illustrated in FIG. 1.

FIG. 4 is an exploded assembly view of the dual grind head and dual grind assembly of the grinder illustrated in FIG. 1.

FIG. 5 is a perspective view of a dual grind auger stud according to certain embodiments, which may be utilized in connection with the dual grind assembly illustrated in FIG. 1.

FIG. 6 is a side view of the dual grind auger stud illustrated in FIG. 5.

FIG. 7 is a schematic flow diagram of a process according to certain embodiments.

FIG. 8 is a cross-sectional view of the dual grind assembly installed to the head and auger.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

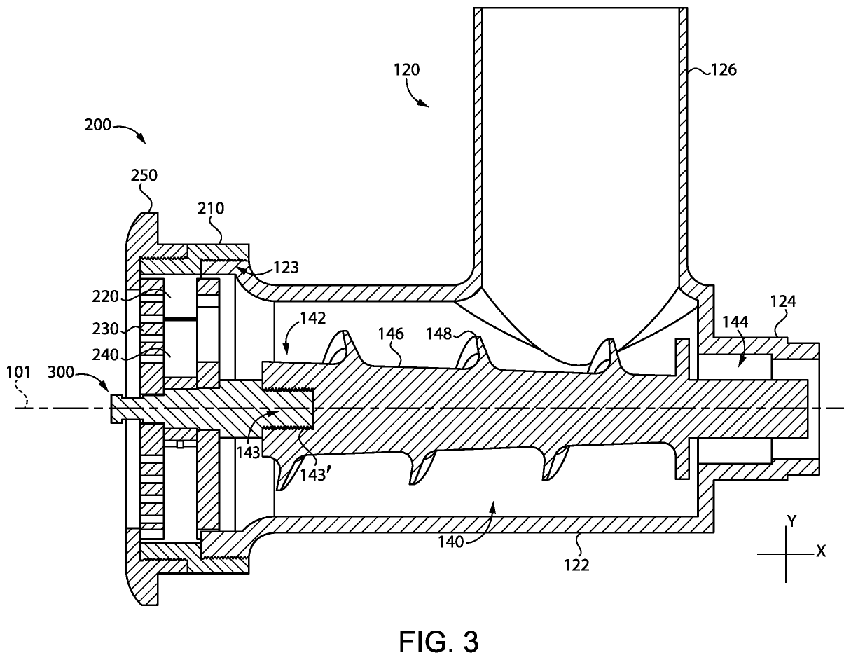

As used herein, the terms “longitudinal,” “lateral,” and “transverse” may be used to denote motion or spacing along three mutually perpendicular axes, wherein each of the axes defines two opposite directions. In the coordinate system illustrated in FIG. 3, the X-axis defines first and second longitudinal directions, including a proximal direction (to the left in FIG. 3) and an opposite distal direction (to the right in FIG. 3), the Y-axis defines first and second lateral directions, and the Z-axis (into and out of the page) defines first and second transverse directions. These terms are used for ease and convenience of description, and are without regard to the orientation of the system with respect to the environment. For example, descriptions that reference a longitudinal direction may be equally applicable to a vertical direction, a horizontal direction, or an off-axis orientation with respect to the environment.

Furthermore, motion or spacing along a direction defined by one of the axes need not preclude motion or spacing along a direction defined by another of the axes. For example, elements that are described as being “laterally offset” from one another may also be offset in the longitudinal and/or transverse directions, or may be aligned in the longitudinal and/or transverse directions. Moreover, the term “transverse” may also be used to describe motion or spacing that is non-parallel to a particular axis or direction. For example, an element that is described as being “movable in a direction transverse to the longitudinal axis” may move in a direction that is perpendicular to the longitudinal axis and/or in a direction oblique to the longitudinal axis. The terms are therefore not to be construed as limiting the scope of the subject matter described herein to any particular arrangement unless specified to the contrary.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

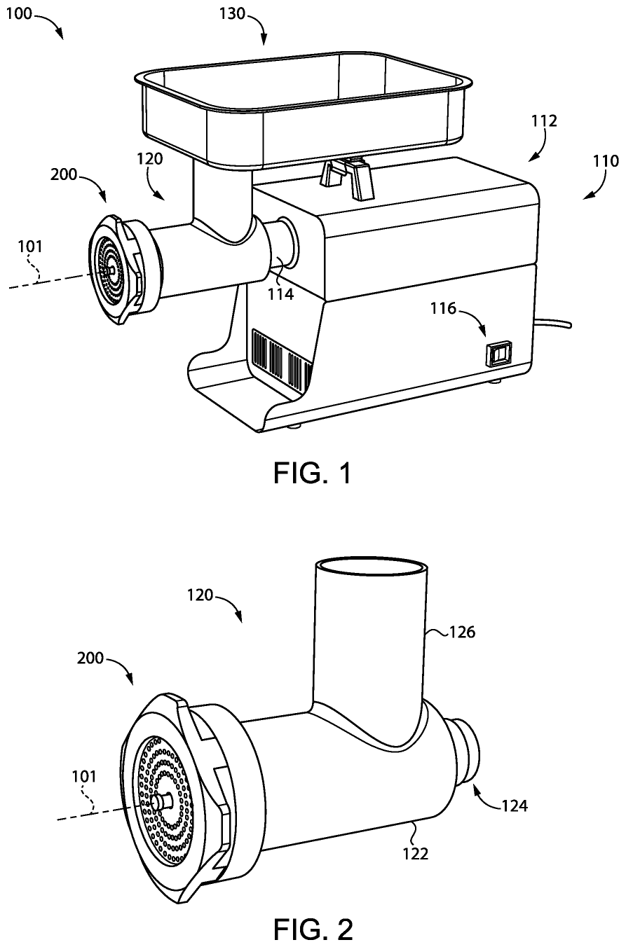

With reference to FIG. 1, illustrated therein is a grinder 100 according to certain embodiments. The grinder 100 generally includes a main body 110, a head 120 releasably mounted to the main body 110, a feed pan 130 releasably mounted to the head 120, and a dual grind assembly 200 according to certain embodiments. As described herein, a grindable product (e.g., a food product such as meat) may be stored in the feed pan 130 and directed to the grind assembly 200 by an auger 140 (FIG. 3) that is driven by a motor 112 of the main body 110.

The main body 110 houses a motor 112 configured to rotate the auger 140 about a rotational axis 101, and provides a base to which the head 120 is releasably mounted. The main body 110 includes a first mounting tube 114 that is positioned adjacent the motor 112 and to which the head 120 is mounted. The main body 110 may further include a power switch 116 that controls operation of the motor 112. In certain embodiments, the switch 116 may be an on/off switch. In certain embodiments, the switch 116 may provide multiple speed settings and/or a reverse for the motor 112. As described herein, the motor 112 is operable to rotate the auger 140 to thereby power the dual grind assembly 200.

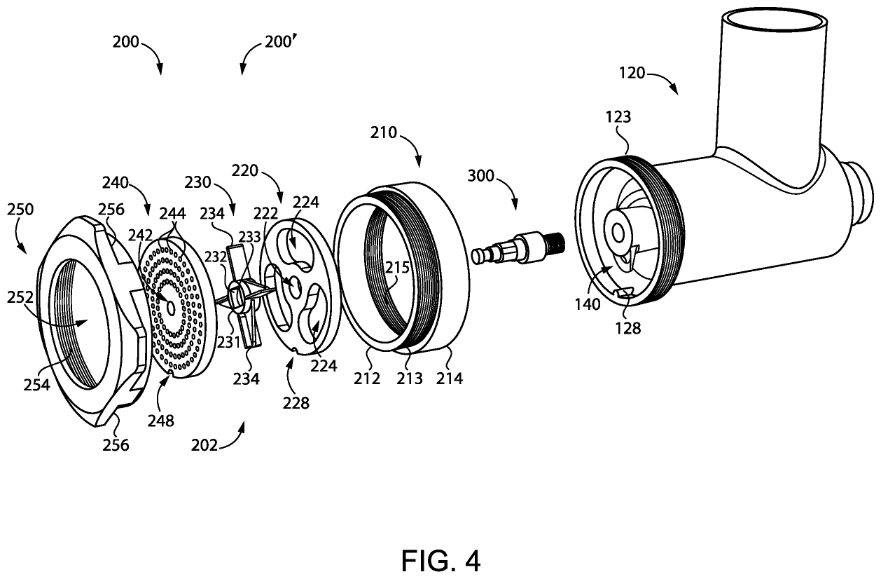

With additional reference to FIGS. 2 and 3, the head 120 generally includes a longitudinally-extending auger tube 122, a second mounting tube 124 positioned on a distal end of the auger tube 122, and a feed tube 126 that extends upward from the auger tube 122. The second mounting tube 124 is sized and shaped for coupling with the first mounting tube 114 for releasable mounting of the head 120 to the main body 110. The feed tube 126 is open to the auger tube 122, and directs the grindable product from the feed pan 130 to the auger tube 122. In the illustrated form, the proximal end portion of the auger tube 122 comprises external threads 123 (FIG. 4). In the illustrated form, the first mounting tube 114 is a female mounting tube, and the second mounting tube 124 is a male mounting tube configured to be received in the first mounting tube 114. It is also contemplated that the first mounting tube 114 may be a male mounting tube, and that the second mounting tube 124 may be a female mounting tube configured to receive the first mounting tube 114.

The feed pan 130 is mounted to the feed tube 126 above the auger tube 122, and stores the product that is to be ground by the grinder 100. The feed pan 130 includes an opening that is open to the feed tube 126 such that product within the feed pan 130 can be directed to the auger tube 122.

The auger 140 is mounted in the auger tube 122, and has a proximal end portion 142, a distal end portion 144, a body portion 146, and a helical ramp 148 wrapped about the body portion 146. The proximal end portion 142 includes a threaded recess 143, which receives a stem 314 of an auger stud 300 as described herein. The threaded recess 143 includes internal threads 143′. The distal end portion 144 extends into the second mounting tube 124, and is configured for coupling with the motor 112 such that the motor 112 is operable to rotate the auger 140. The helical ramp 148 wraps about the body portion 146, and proximally drives the product from the distal end of the auger tube 122 toward the dual grind assembly 200 as the auger 140 is rotated in a first or grinding direction.

With additional reference to FIG. 4, the dual grind assembly 200 generally includes an adapter ring portion 210 mounted to the proximal end of the auger tube 122, a first grind plate 220, a second grind plate 240, a grind knife 230 positioned between the grind plates 220, 240, a retention ring 250, and an auger stud 300 according to certain embodiments. As described herein, the auger stud 300 is releasably coupled to the auger 140, and drives the grind knife 230 to facilitate grinding of the grindable product. Moreover, the first grind plate 220, the dual grind knife 230, and the second grind plate 240 are operable to be sequentially loaded onto the auger stud 300 in a proximal-to-distal direction, and may be referred to herein as the loadable components 202.

The adapter ring portion 210 generally includes a proximal ring portion 212 and a distal ring portion 214. The proximal ring portion 212 is configured for coupling with the retention ring 250, and in the illustrated form includes external threads 213. The distal ring portion 214 is configured for coupling with the auger tube 122, and in the illustrated form includes internal threads 215 that mate with the external threads 123 of the head 120. In the illustrated form, the outer diameter of the proximal ring portion 212, the inner diameter of the distal ring portion 214, the inner diameter of the internal threads 254 of the retention ring 250, and the outer diameter of the external threads 123 of the head 120 all correspond to one another. As such, the internal threads 254 of the retention ring 250 are configured to mate with each of the external threads 213 of the proximal ring portion 212 and the external threads 123 of the head 120. Thus, when the adapter ring portion 210 is removed, the retention ring 250 may be mounted directly to the head 120. These features may facilitate the conversion of the grinder 100 between a dual-stage grind configuration and a single-stage grind configuration.

The first grind plate 220 is mounted to the auger stud 300, and includes a central aperture 222 through which the auger stud 300 extends. The first grind plate 220 also includes a plurality of first product apertures 224 through which the product passes for grinding under the urging of the rotating auger 140. In the illustrated form, the first grind plate 220 is generally circular, and includes a groove 228 that interfaces with a spline 128 of the head 120 to thereby rotationally couple the first grind plate 220 with the head 120.

The dual grind knife 230 is mounted to the auger stud 300, and generally includes a hub 231 defining a non-circular central opening 232 sized and shaped to mate with a corresponding portion of the auger stud 300. The dual grind knife 230 also includes a plurality of blades 234 that extend outward from the hub 231. As described herein, the grind knife 230 rotates with the auger stud 300, and thereby facilitates shredding and/or grinding of the product being processed. As will be appreciated, both the proximal and distal sides of the knife blades 234 may be sharpened to facilitate the cutting, shredding, and/or grinding of the product.

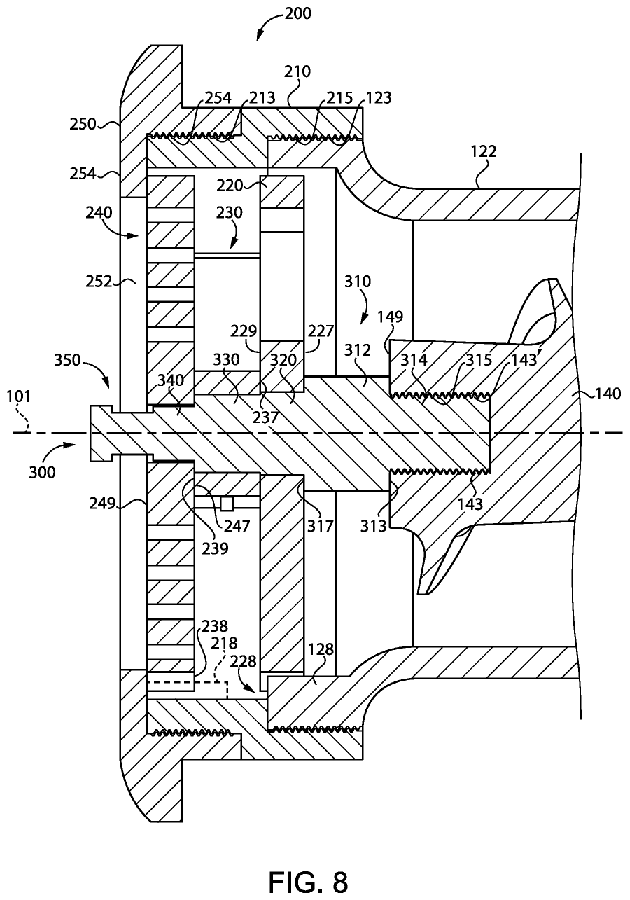

The second grind plate 240 is also mounted to the auger stud 300, and similarly includes a central aperture 242 through which the auger stud 300 extends. The second grind plate 220 also includes a plurality of second product apertures 244 through which product passes under the urging of the rotating auger 140. While other forms are contemplated, in the illustrated embodiment, the second product apertures 244 are smaller in size and greater in number than the first product apertures 224. In the illustrated form, the second grind plate 240 is generally circular, and includes a groove 248 similar to the groove 228. The groove 248 may interface with the spline 218 to thereby prevent rotation of the second grind plate 240, such as in embodiments in which the grinder 100 is provided in its single-grind configuration. In certain embodiments, the adapter ring portion 210 may include a spline similar 218 (FIG. 8) to the spline 128 such that the adapter ring portion 210 prevents rotation of the second grind plate 240.

The retention ring 250 is generally annular, and includes a proximal central opening 252 and a distal portion including internal threads 254. The diameter of the central opening 252 is less than that of the second grind plate 240 such that the retention ring 250 restricts proximal movement of the grind plate 240, thereby maintaining the dual grind assembly 200 in an assembled state. The internal threads 254 are operable to mate with each of the external threads 213 of the adapter ring portion 210 and the external threads 123 of the head 120. The retention ring 250 may include one or more extensions and/or one or more flats 256 to facilitate the act of rotating the retention ring 250 relative to the adapter ring portion 210 for mounting and removal of the retention ring 250.

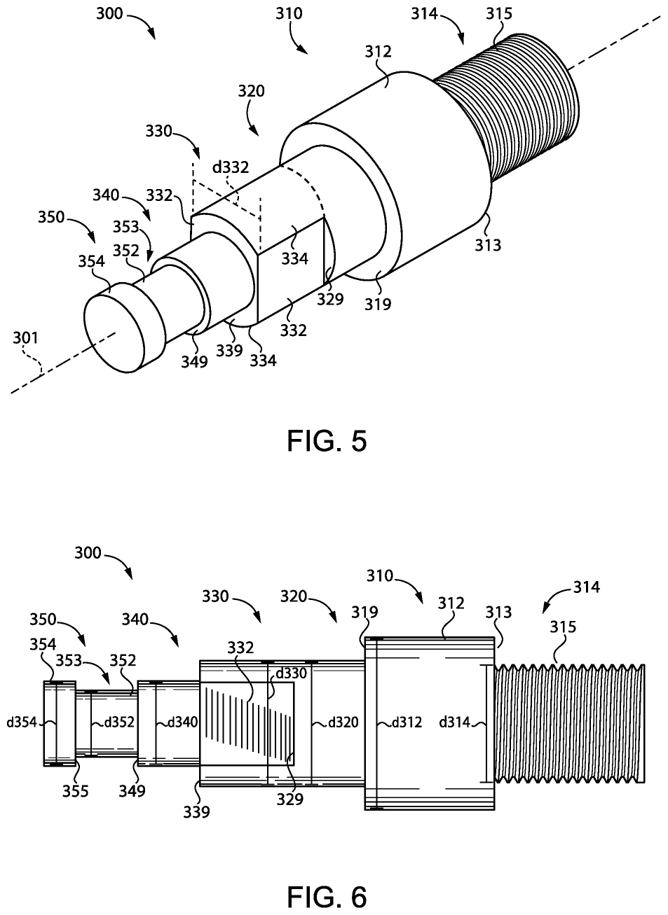

With additional reference to FIGS. 5 and 6, the auger stud 300 extends along a longitudinal rotational axis 301 that defines a proximal direction (downward and to the left in FIG. 5) and an opposite distal direction (upward and to the right in FIG. 5). The auger stud 300 generally includes a distal end section 310, a first grind plate mounting section 320 positioned proximally of the distal end section 310, a second grind plate mounting section 340 positioned proximally of the first grind plate mounting section 320, a grind knife mounting section 330 positioned between the grind plate mounting sections 320, 340, and a proximal end section 350.

The distal end section 310 is positioned at the distal end of the auger stud 300, and generally includes an enlarged diameter portion 312 and a stem 314 extending distally from the enlarged diameter portion 312. The enlarged diameter portion 312 may also be referred to herein as a body portion of the auger stud 300. The stem 314 is configured to mate with the proximal end portion of the auger 140, and in the illustrated embodiment includes external threads 315 that mate with the internal threads 143′ of the auger 140 to thereby couple the auger stud 300 and the auger 140 for joint rotation. The enlarged diameter portion 312 has an enlarged diameter d312, and the stem 314 has a stem diameter d314 less than the enlarged diameter d312 such that a distal-facing shoulder 313 is formed at the distal end of the enlarged diameter portion 312. In the illustrated form, the body portion 312 defines a maximum diameter of the auger stud 300.

The first grind plate mounting section 320 is positioned proximally of the distal end section 310, and is configured to rotatably support the first grind plate 220. The illustrated first grind plate mounting section 320 is circular in cross-section, and has a diameter d320 corresponding to that of the circular central aperture 222 of the first grind plate 220 such that the first grind plate mounting section 320 is operable to rotatably support the first grind plate 220. Thus, the auger stud 300 remains capable of rotating when the first grind plate 220 is rotationally coupled with the head 120 (e.g., by engagement of the spline 128 and groove 228). The first grind plate mounting section 320 has a first grind plate mounting section diameter d320 that is less than the enlarged diameter d312 such that a proximal-facing shoulder 319 is formed at the proximal end of the enlarged diameter portion 312.

The grind knife mounting section 330 is positioned between the first grind plate mounting section 320 and the second grind plate mounting section 340. The grind knife mounting section 330 has a non-circular cross-sectional geometry sized and shaped to mate with the central aperture 232 of the grind knife 230 to thereby rotationally couple the auger stud 300 and the grind knife 230. The non-circular cross-sectional geometry of the grind knife mounting section 330 may include a flat 332 configured to engage a corresponding flat 233 of the grind knife central aperture 232, and in the illustrated form includes a pair of flats 332 positioned diametrically opposite one another. In the illustrated form, the flats 332 are connected by a pair of arcuate surfaces 334. It is also contemplated that the flats 332 may be connected by one or more additional flats. The grind knife mounting section 330 has a major diameter d330 corresponding to the first grind plate mounting section diameter d320, and a minor diameter d332 that extends between the flats 332. The minor diameter d332 is less than the major diameter d330, and is less than the first grind plate mounting section diameter d320 such that a pair of proximal-facing shoulders 329 are formed at the distal ends of the flats 332.

The second grind plate mounting section 340 is positioned proximally of the first grind plate mounting section 320, and is configured to rotatably support the second grind plate 240. The illustrated second grind plate mounting section 340 is circular in cross-section, and has a diameter d340 corresponding to that of the circular central aperture 242 of the second grind plate 240 such that the second grind plate mounting section 340 is operable to rotatably support the second grind plate 240. Thus, the auger stud 300 remains capable of rotating even in the event that the second grind plate 240 is rotationally locked (e.g., by engagement of a spline 218 with the groove 248).

The second grind plate mounting section 340 has a second grind plate mounting section diameter d340, which is less than the major diameter d330 of the grind knife mounting section 330 such that a proximal-facing shoulder 339 is formed at the proximal end of the grind knife mounting section 330. In the illustrated form, the diameter d340 of the second grind plate mounting section 340 is less than the diameter d320 of the first grind plate mounting section 320. It is also contemplated that the first grind plate mounting section 320 and the second grind plate mounting section 340 may be of the same diameter, for example in embodiments in which the central apertures 222, 242 of the grind plates 220, 240 are of the same diameter. However, it has been found that providing the mounting sections 320, 340 with different diameters may facilitate installation of the grind assembly 200 as described herein.

The proximal end section 350 defines the proximal end of the auger stud 300, and generally includes a reduced diameter portion 352 and a tip 354, each of which has a circular cross-sectional geometry in the illustrated embodiment. The reduced diameter portion 352 has a lesser diameter d352 than the portions of the auger stud 300 on either side of the reduced diameter portion 352, and may be considered to define an annular channel 353. In the illustrated embodiment, the reduced diameter portion 352 has a reduced diameter d352, which is less than the diameter d354 of the tip 354 and the diameter d340 of the second grind plate mounting section 340, which correspond to one another. As a result, a proximal-facing shoulder 349 is formed at the proximal end of the second grind plate mounting portion 340, and a distal-facing shoulder 355 is formed at the distal end of the tip 354.

In certain embodiments, one or more components of the grind assembly 200 may be provided in a retrofit kit 200′ configured for use with the grinder 100. The illustrated retrofit kit 200′ includes the auger stud 300, and may further include the adapter ring portion 210 and/or the grind knife 230. In certain embodiments, the original grinder 100 may have been provided with one or both of the grind plates 220, 240. In such forms, one or both of the grind plates 220, 240 may be omitted from the retrofit kit 200′. In certain embodiments, one or both of the grind plates 220, 240 may be provided with the retrofit kit 200′. In certain embodiments, the retrofit kit 200′ may be configured for use with the original retention ring 250 provided with the original grinder 100. It is also contemplated that the retrofit kit 200′ may include a retention ring configured for use with the adapter ring portion 210, or another component that combines the features and functions of the adapter ring portion 210 and the retention ring 250.

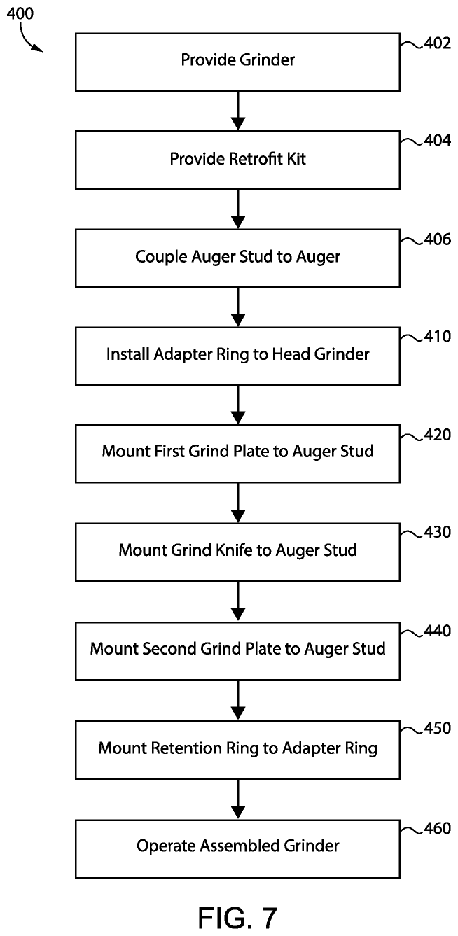

With additional reference to FIG. 7, an exemplary process 400 that may be performed using the grinder 100 is illustrated. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 400 is described herein with specific reference to the grinder 100, grind assembly 200, and auger stud 300 illustrated in FIGS. 1-6, it is to be appreciated that the process 400 may be performed with grinders, grind assemblies, and/or auger studs having additional and/or alternative features.

The process 400 may begin with the grinder 100 in a partially-assembled state, in which the head 120 is mounted to the main body 110, and the auger 140 is coupled with the motor 112. In certain embodiments, the process 400 may be utilized to convert the grinder 100 from a single-stage grind configuration to a multi-stage grind configuration.

The process 400 may include block 402, which generally involves providing a grinder including a head and an auger rotatably mounted in the head. For example, block 402 may involve providing at least a portion of the grinder 100 illustrated in FIG. 1, which generally includes a head 120 and an auger 140 rotatably mounted in the head 120. In certain embodiments, the grinder may be a powered grinder that further includes a motor 112 operable to rotate the auger 140. It is also contemplated that the grinder may not necessarily include a motor and may, for example, be manually powered. In certain embodiments, the grinder provided in block 402 may further include at least one grind plate and/or a retention ring operable to couple with the head 120. For example, the grinder 100 may be provided with the first grind plate 220, the second grind plate 240, and/or the retention ring 250.

The process 400 may include block 404, which generally involves providing a retrofit kit for the grinder 100. The retrofit kit provided in block 404 generally includes the auger stud 300, and may further include the adapter ring portion 210. The retrofit kit provided in block 404 may, for example, take any of the forms described above with reference to the retrofit kit 200′.

The process 400 may include block 406, which generally involves coupling an auger stud with the auger. In the illustrated form, block 406 involves inserting the stem 314 into the threaded recess 143 and causing relative rotation of the auger 140 and the auger stud 300 to thereby cause the internal threads 143′ of the threaded recess 143 to mate with the external threads 315 of the stem 314. Such relative rotation may be continued until a distal-facing shoulder 313 of the enlarged diameter portion 312 abuts a proximal face 149 of the auger 140.

The process 400 may include block 410, which generally involves installing an adapter ring to a head of the grinder. For example, block 410 may involve installing the adapter ring 210 to the head 120. In the illustrated form, such installation involves mating the internal threads 215 of the distal ring portion 214 with the external threads 123 of the head 120. It is also contemplated that block 410 may include installing the adapter ring in another manner, such as via a bayonet fitting or another coupling mechanism. Moreover, while FIG. 7 illustrates the installation of block 410 occurring prior to the assembly of the grind assembly, it should be appreciated that the installation of block 410 may occur during or after the assembly of the grind assembly. For example, the adapter ring 210 may be mounted to the head 120 following the mounting of the grind knife to the auger stud in block 430.

In certain embodiments, the installation of the adapter ring 210 may involve the installation of a fastener to retain the position of the adapter ring. For example, a fastener such as a bolt or set screw may engage both the adapter ring 210 and the head 120 to prevent rotation of the adapter ring 210 relative to the head 120, thereby discouraging the unintentional loosening of the adapter ring 210 during operation of the device. In certain embodiments, the fastener may include a grip to facilitate manual manipulation of the fastener.

The process 400 may include block 420, which generally involves mounting the first grind plate 220 to the auger stud 300 such that the auger stud 300 rotatably supports the first grind plate 220. More particularly, block 420 includes inserting the auger stud 300 into the central aperture 222 of the first grind plate 220, and moving the first grind plate 220 into alignment with the first grind plate mounting section 320. For example, block 420 may involve moving the first grind plate 220 distally along the auger stud 300 until a distal surface 227 of the first grind plate 220 abuts the proximal-facing shoulder 319 of the enlarged diameter section 312. In certain embodiments, block 420 may include rotationally coupling the first grind plate 220 with the head 120, for example by engaging the spline 128 with the groove 228.

The process 400 may include block 430, which generally involves mounting the grind knife 230 to the auger stud 300 such that the auger stud 300 is rotationally coupled with the grind knife 230. More particularly, block 430 includes inserting the auger stud 300 into the central aperture 232 of the grind knife 230, and moving the grind knife 230 into alignment with the grind knife mounting section 330. For example, block 430 may involve moving the grind knife 230 distally along the auger stud 300 until a distal surface 237 of the grind knife 230 abuts the proximal-facing shoulders 329 adjacent the flats 332 and/or the proximal surface 229 of the first grind plate 220. With the grind knife 230 so installed, the grind knife 230 is rotationally coupled with the auger stud 300 such that the auger 140 is operable to rotate the grind knife 230.

The process 400 may include block 440, which generally involves mounting the second grind plate 240 to the auger stud 300 such that the auger stud 300 rotatably supports the second grind plate 240. More particularly, block 440 includes inserting the auger stud 300 into the central aperture 242 of the second grind plate 240, and moving the second grind plate 240 into alignment with the second grind plate mounting section 340. For example, block 440 may involve moving the second grind plate 240 distally along the auger stud 300 until the distal surface 247 of the second grind plate 240 abuts the proximal-facing shoulder 339 of the grind knife mounting section 330 and/or a proximal surface 339 of the grind knife 330.

The process 400 may include block 450, which generally involves mounting the retention ring 250 to the adapter ring 210. In the illustrated form, such installation involves mating the internal threads 254 of the retention ring 250 with the external threads 213 of the distal ring portion 212 of the adapter ring portion 210. It is also contemplated that block 410 may include installing the retention ring 250 in another manner, such as via a bayonet fitting or another coupling mechanism.

The process 400 may include block 460, which generally involves operating the assembled grinder to thereby grind a food product. Block 460 may, for example, involve operating the motor 112 to thereby rotate the auger 140. With the auger stud 300 rotationally coupled to the auger 140 and the grind knife 230, such rotation of the auger 140 also rotates the auger stud 300 and the grind knife 230, thereby slicing and/or shredding the food product that is being urged through the grind plates 220, 240 by the auger 140. In certain embodiments, block 460 may involve preventing rotation of the first grind plate 220, for example by maintaining engagement between the spline 128 and the groove 228. In certain embodiments, block 460 may involve preventing rotation of the second grind plate 240, for example by maintaining engagement between a spline 218 and the groove 248.

As should be appreciated from the foregoing, in the illustrated embodiment, all loadable components 202 of the grind assembly 200 (viz., the first grind plate 220, the grind knife 230, and the second grind plate 240) can be loaded onto the auger stud 300 by moving the loadable component 202 in the proximal-to-distal direction relative to the auger stud 300. This feature may, for example, enable the loadable components 202 to be loaded onto the auger stud 300 while the auger stud 300 remains coupled to the auger 140. This is in contrast to certain existing adapter kits, in which two components must be loaded onto the auger stud in opposite directions. Thus, the illustrated grind assembly 200 may facilitate assembly of the grinder 100 in its multi-stage grind configuration by enabling the components 202 to be loaded and unloaded while the auger stud 300 remains installed to the auger 140. Moreover, if the user wishes to replace one or both of the grind plates 220, 240 and/or the grind knife 230, such replacement can be achieved without removing the auger stud 300 from the auger 140.

Certain embodiments of the present application relate to an auger stud extending along a longitudinal rotational axis that defines a proximal direction and a distal direction opposite the proximal direction, the auger stud comprising: a body portion; a stem extending distally from the body portion; a first grind plate mounting section positioned proximally of the body portion, the first grind plate mounting section having a first circular cross-sectional geometry; a second grind plate mounting section positioned proximally of the first grind plate mounting section, the second grind plate mounting section having a second circular cross-sectional geometry; and a grind knife mounting section positioned between the first grind plate mounting section and the second grind plate mounting section, the grind knife mounting section having a first non-circular cross-sectional geometry.

In certain embodiments, the first non-circular cross-sectional geometry comprises a first flat.

In certain embodiments, the first flat is defined adjacent a proximal-facing shoulder defined by a proximal end of the first grind plate mounting section.

In certain embodiments, the first non-circular cross-sectional geometry further comprises a second flat.

In certain embodiments, the first flat and the second flat are diametrically opposite one another.

In certain embodiments, the first flat and the second flat are connected by a pair of arcuate surfaces.

In certain embodiments, the body portion has a body portion diameter; wherein the stem has a stem diameter; and wherein the stem diameter is less than the body portion diameter such that a distal-facing shoulder is formed by a distal end of the body portion.

In certain embodiments, the body portion has a body portion diameter; wherein the first grind plate mounting section has a first grind plate mounting section diameter; and wherein the first grind plate mounting section diameter is less than the body portion diameter such that a proximal-facing shoulder is formed by a proximal end of the body portion.

In certain embodiments, the second grind plate mounting section has a second grind plate mounting section diameter; and wherein the second grind plate mounting section diameter is less than a diameter of the grind knife mounting section such that a proximal-facing shoulder is formed by a proximal end of the grind knife mounting section.

In certain embodiments, the auger stud further comprises a proximal end portion positioned proximally of the second grind plate mounting section, wherein the proximal end portion comprises an annular channel.

In certain embodiments, the stem is threaded.

Certain embodiments of the present application relate to a grind assembly comprising the auger stud of claim 1, the grind assembly further comprising: a first grind plate comprising a first grind plate central aperture in which the first grind plate mounting section is seated such that the first grind plate is rotatably supported by the auger stud; a grind knife comprising a grind knife central aperture in which the grind knife mounting section is seated, the second central aperture having a second non-circular cross-sectional geometry that mates with the first non-circular cross-sectional geometry to thereby rotationally couple the auger stud with the grind knife; and a second grind plate comprising a second grind plate central aperture in which the second grind plate mounting section is seated such that the second grind plate is rotatably supported by the auger stud.

In certain embodiments, the grind assembly further comprises: an adapter ring including a proximal ring portion and a distal ring portion, wherein the proximal ring portion comprises a external threading, and wherein the distal ring portion is configured for attachment to a head of a grinder; and a retention ring including an internal threading configured to mate with the external threading; wherein a collar of the retention ring is configured to abut a proximal surface of the second grind plate to thereby prevent removal of the second grind plate from the auger stud.

Certain embodiments of the present application relate to a kit for a grinder comprising a head and an auger rotatably mounted in the head, the kit comprising: an auger stud extending along a longitudinal rotational axis that defines a proximal direction and a distal direction opposite the proximal direction, the auger stud comprising: a body portion; a stem extending distally from the body portion and configured to rotationally couple with the auger; a first grind plate mounting section positioned proximally of the body portion, the first grind plate mounting section configured to rotatably support a first grind plate; a second grind plate mounting section positioned proximally of the first grind plate mounting section, the second grind plate mounting section configured to rotatably support a second grind plate; and a grind knife mounting section positioned between the first grind plate mounting section and the second grind plate mounting section; and a grind knife comprising a grind knife central aperture configured to pass over the second grind plate mounting section, to rotationally couple with the grind knife mounting section, and to prevent insertion of the first grind plate mounting section.

In certain embodiments, the kit further comprises a first grind plate comprising a first grind plate central aperture configured to pass over the second grind plate mounting section and the grind knife mounting section, and to rotatably receive the first grind plate mounting section.

In certain embodiments, the kit further comprises a second grind plate comprising a second grind plate central aperture configured to rotatably receive the second grind plate mounting section and to prevent insertion of the grind knife mounting section.

In certain embodiments, the kit further comprises an adapter ring, the adapter ring comprising:
a distal ring portion comprising first internal threads configured to mate with first external threads of the head; and
a proximal ring portion comprising second external threads configured to mate with second internal threads of a retention ring.

In certain embodiments, the first internal threads, the first external threads, the second internal threads, and the second external threads share a common effective diameter.

In certain embodiments, the body portion defines a maximum diameter of the auger stud.

In certain embodiments, the auger stud further comprises a proximal end section positioned proximally of the second grind plate mounting section; and wherein the proximal end section comprises an annular channel.

In certain embodiments, the stem is threaded.

Certain embodiments of the present application relate to a grind assembly, comprising: an auger stud configured for rotation about a longitudinal rotational axis that defines a proximal direction and an opposite distal direction, the auger stud comprising: a body portion comprising a first proximal-facing shoulder; a stem extending distally from the body portion, the stem configured for coupling with an auger; a first grind plate mounting section positioned proximally of the body portion; a grind knife mounting section positioned proximally of the first grind plate mounting section; and a second grind plate mounting section positioned proximally of the grind knife mounting section; a first grind plate rotatably supported by the first grind plate mounting section; a grind knife rotationally coupled with the grind knife mounting section; and a second grind plate rotatably supported by the second grind plate mounting section.

In certain embodiments, each of the first grind plate, the grind knife, and the second grind plate is operable to be loaded onto the auger stud in a proximal-to-distal direction.

In certain embodiments, a distal side of the first grind plate abuts a proximal-facing shoulder of the body portion.

In certain embodiments, a distal side of the grind knife abuts a proximal-facing shoulder of the first grind plate mounting section.

In certain embodiments, a distal side of the second grind plate abuts a proximal-facing shoulder of the grind knife mounting section.

Certain embodiments of the present application relate to a method, comprising: loading a first grind plate onto an auger stud, comprising moving the first grind plate relative to the auger stud in a proximal-to-distal direction until a distal surface of the first grind plate abuts a first proximal-facing shoulder of the auger stud; after loading the first grind plate onto the auger stud, loading a grind knife onto the auger stud, comprising moving the grind knife relative to the auger stud in the proximal-to-distal direction until a distal surface of the grind knife abuts a second proximal-facing shoulder of the auger stud and/or a proximal surface of the first grind plate; and after loading the grind knife onto the auger stud, loading a second grind plate onto the auger stud, comprising moving the second grind plate relative to the auger stud in the proximal-to-distal direction until a distal surface of the second grind plate abuts a third proximal-facing shoulder of the auger stud and/or a proximal surface of the grind knife.

In certain embodiments, with the first grind plate loaded onto the auger stud, the auger stud rotatably supports the first grind plate.

In certain embodiments, with the grind knife loaded onto the auger stud, the auger stud is rotationally coupled with the grind knife.

In certain embodiments, with the second grind plate loaded onto the auger stud, the auger stud rotatably supports the second grind plate.

In certain embodiments, the method further comprises rotationally coupling the auger stud with an auger of a grinder; wherein rotationally coupling the auger stud with the auger comprises inserting a stem of the auger stud into a recess of the auger.

In certain embodiments, rotationally coupling the auger stud with the auger further comprises engaging first screw threads of the stem with second screw threads of the auger.

In certain embodiments, the method further comprises: engaging a distal end portion of an adapter ring with a head of a grinder; engaging a distal end portion of a retention ring with a proximal end portion of the adapter ring; and engaging a collar of the retention ring with a proximal surface of the second grind plate, thereby restricting movement of the second grind plate in a distal-to-proximal direction.

Certain embodiments of the present application relate to a method of converting a grinder from a single-stage grind configuration to a multi-stage grind configuration, the method comprising: rotationally coupling an auger stud with an auger of the grinder such that the auger stud extends proximally from the auger; loading a first grind plate onto the auger stud such that the auger stud rotatably supports the first grind plate; loading a grind knife onto the auger stud such that the grind knife is rotationally coupled with the auger stud; loading a second grind plate onto the auger stud such that the auger stud rotatably supports the second grind plate; coupling an adapter ring with a head of the grinder; coupling a retention ring with the adapter ring such that a collar of the retention ring is positioned proximally of the second grind plate and inhibits removal of the second grind plate from the auger stud.

In certain embodiments, the method further comprises rotationally coupling the first grind plate with the head.

In certain embodiments, rotationally coupling the auger stud with the auger comprises engaging first threads of the auger with second threads of the auger stud.

In certain embodiments, rotationally coupling the auger stud with the auger further comprises causing relative rotation of the auger and the auger stud until a proximal face of the auger abuts a distal-facing shoulder of the auger stud.

In certain embodiments, loading the first grind plate onto the auger stud comprises moving the first grind plate relative to the auger stud in a proximal-to-distal direction; wherein loading the grind knife onto the auger stud is performed after loading the first grind plate onto the auger stud and comprises moving the grind knife relative to the auger stud in the proximal-to-distal direction; and wherein loading the second grind plate onto the auger stud is performed after loading the grind knife onto the auger stud and comprises moving the second grind plate relative to the auger stud in the proximal-to-distal direction.

In certain embodiments, the first grind plate is loaded onto the auger stud after the auger stud has been rotationally coupled with the auger.

In certain embodiments, the grind knife is loaded onto the auger stud after the first grind plate has been loaded onto the auger stud.

In certain embodiments, the second grind plate is loaded onto the auger stud after the grind knife has been loaded onto the auger stud.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An auger stud extending along a longitudinal rotational axis that defines a proximal direction and a distal direction opposite the proximal direction, the auger stud comprising:
a body portion;
a stem extending distally from the body portion;
a first grind plate mounting section positioned proximally of the body portion, the first grind plate mounting section having a first circular cross-sectional geometry;
a second grind plate mounting section positioned proximally of the first grind plate mounting section, the second grind plate mounting section having a second circular cross-sectional geometry; and
a grind knife mounting section positioned between the first grind plate mounting section and the second grind plate mounting section, the grind knife mounting section having a first non-circular cross-sectional geometry.

2. The auger stud of claim 1, wherein the first non-circular cross-sectional geometry comprises a first flat.

3. The auger stud of claim 2, wherein the first flat is defined adjacent a proximal-facing shoulder defined by a proximal end of the first grind plate mounting section.

4. The auger stud of claim 2, wherein the first non-circular cross-sectional geometry further comprises a second flat.

5. The auger stud of claim 4, wherein the first flat and the second flat are diametrically opposite one another.

6. The auger stud of claim 4, wherein the first flat and the second flat are connected by a pair of arcuate surfaces.

7. The auger stud of claim 1, wherein the body portion has a body portion diameter;
wherein the stem has a stem diameter; and
wherein the stem diameter is less than the body portion diameter such that a distal-facing shoulder is formed by a distal end of the body portion.

8. The auger stud of claim 1, wherein the body portion has a body portion diameter;
wherein the first grind plate mounting section has a first grind plate mounting section diameter; and
wherein the first grind plate mounting section diameter is less than the body portion diameter such that a proximal-facing shoulder is formed by a proximal end of the body portion.

9. The auger stud of claim 1, wherein the second grind plate mounting section has a second grind plate mounting section diameter; and
wherein the second grind plate mounting section diameter is less than a diameter of the grind knife mounting section such that a proximal-facing shoulder is formed by a proximal end of the grind knife mounting section.

10. The auger stud of claim 1, further comprising a proximal end portion positioned proximally of the second grind plate mounting section, wherein the proximal end portion comprises an annular channel.

11. The auger stud of claim 1, wherein the stem is threaded.

12. A grind assembly comprising the auger stud of claim 1, the grind assembly further comprising:
a first grind plate comprising a first grind plate central aperture in which the first grind plate mounting section is seated such that the first grind plate is rotatably supported by the auger stud;
a grind knife comprising a grind knife central aperture in which the grind knife mounting section is seated, the second central aperture having a second non-circular cross-sectional geometry that mates with the first non-circular cross-sectional geometry to thereby rotationally couple the auger stud with the grind knife; and
a second grind plate comprising a second grind plate central aperture in which the second grind plate mounting section is seated such that the second grind plate is rotatably supported by the auger stud.

13. The grind assembly of claim 12, further comprising:
an adapter ring including a proximal ring portion and a distal ring portion, wherein the proximal ring portion comprises a external threading, and wherein the distal ring portion is configured for attachment to a head of a grinder; and
a retention ring including an internal threading configured to mate with the external threading;
wherein a collar of the retention ring is configured to abut a proximal surface of the second grind plate to thereby prevent removal of the second grind plate from the auger stud.

14. A kit for a grinder comprising a head and an auger rotatably mounted in the head, the kit comprising:
an auger stud extending along a longitudinal rotational axis that defines a proximal direction and a distal direction opposite the proximal direction, the auger stud comprising:
a body portion;
a stem extending distally from the body portion and configured to rotationally couple with the auger;
a first grind plate mounting section positioned proximally of the body portion, the first grind plate mounting section configured to rotatably support a first grind plate;
a second grind plate mounting section positioned proximally of the first grind plate mounting section, the second grind plate mounting section configured to rotatably support a second grind plate; and
a grind knife mounting section positioned between the first grind plate mounting section and the second grind plate mounting section; and
a grind knife comprising a grind knife central aperture configured to pass over the second grind plate mounting section, to rotationally couple with the grind knife mounting section, and to prevent insertion of the first grind plate mounting section.

15. The kit of claim 14, further comprising a first grind plate comprising a first grind plate central aperture configured to pass over the second grind plate mounting section and the grind knife mounting section, and to rotatably receive the first grind plate mounting section.

16. The kit of claim 15, further comprising a second grind plate comprising a second grind plate central aperture configured to rotatably receive the second grind plate mounting section and to prevent insertion of the grind knife mounting section.

17. The kit of claim 14, further comprising an adapter ring, the adapter ring comprising:
a distal ring portion comprising first internal threads configured to mate with first external threads of the head; and
a proximal ring portion comprising second external threads configured to mate with second internal threads of a retention ring.

18. The kit of claim 14, wherein the first internal threads, the first external threads, the second internal threads, and the second external threads share a common effective diameter.

19. The kit of claim 14, wherein the body portion defines a maximum diameter of the auger stud.

20. The kit of claim 14, wherein the auger stud further comprises a proximal end section positioned proximally of the second grind plate mounting section; and
wherein the proximal end section comprises an annular channel.

21. The kit of claim 14, wherein the stem is threaded.
